(19) United States
(12) Patent Application Publication
(10) Pub. No.: US 2014/0051464 A1
(43) Pub. Date: Feb. 20, 2014

(54) SERVICE PREQUALIFICATION

(71) Applicant: SOLAVEI, LLC, Bellevue, WA (US)

(72) Inventors: James P. Ryan, Bellevue, WA (US); Ryan K. Wuerch, Medina, WA (US)

(73) Assignee: SOLAVEI, LLC, Bellevue, WA (US)

(21) Appl. No.: 13/827,952

(22) Filed: Mar. 14, 2013

Related U.S. Application Data
(60) Provisional application No. 61/683,349, filed on Aug. 15, 2012.

(51) Int. Cl. H04W 4/02

(52) U.S. Cl. CPC H04W 4/02
USPC 455/456.3

(57) ABSTRACT

The present application describes methods, systems, and apparatuses for prequalifying prospective service subscribers for a service, such as a mobile service, an energy service, a cable television service, and so forth. A prequalification engine receives from a client computing device, prequalification information of a potential service subscriber. The prequalification information includes location information of the potential service subscriber, existing equipment or devices of the potential service subscriber, and the like. The prequalification engine determines, based at least on the prequalification information, whether the potential service subscriber qualifies for a service, and transmits, to the client computing device, an indication that the potential service subscriber does or does not qualify for the service.

### RELATED APPLICATIONS

This application claims priority to U.S. Provisional App. No. 61/683,349, filed Aug. 15, 2012 and entitled “Service Prequalification,” the entire contents of which are hereby incorporated herein by reference in their entirety.

### BACKGROUND

When signing up for new mobile service, a potential subscriber typically purchases a new mobile device. A consumer may be able to purchase a new subscriber identity module (SIM) card to be used with a device that the consumer already owns, but the user must first research to determine that their existing phone is compatible with the mobile service. This can result in delays or lost sales to the service provider.

Also, a user must research whether they live in an area that is serviced by the mobile carrier. Typically, the user views a map of the service area, which may be searchable by address or other information. But the user is not provided with specific information about whether they can receive service in their particular location. The user is also not provided with specific information that tells them a level of service that they can expect, either in their location or using their mobile device.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment suitable for providing a mobile service prequalification service.

FIGS. 2A-C illustrate an interface for a mobile-based coverage checker application, or mobile-web based mobile coverage checker.

FIGS. 3A-F illustrate an interface for a mobile-based device checker application, or mobile-web based mobile device checker.

FIGS. 4-6 illustrate an example interface for providing a web-based mobile service coverage check.

FIGS. 7 and 8 illustrate a web interface for performing a device check.

FIG. 9 is a block diagram of an example computing system usable to provide the social commerce platform.

FIG. 10 illustrates a flow chart depicting a process of service pre qualification.

### DETAILED DESCRIPTION

Embodiments of the present disclosure filter, identify, and prequalify potential service subscribers, such as potential social commerce community members, for a wide range of services, such as mobile service, cable service, energy service, or other service (such as cleaning service, lawn care service, or other service that a person or business may purchase). Service prequalification may be based, in various embodiments, on a wide range of prequalification criteria or information such as service availability location, prospective member interests, a prospective member's existing equipment and devices, and so forth. Example mobile service prequalification services are described herein. But embodiments are not limited to mobile service prequalification services.

The prequalification services may be related to a social commerce platform that enables a social commerce community. A social commerce community may include members or entities that participate in social commerce. In one example, a social commerce community may be a community of members who have signed up for a service, such as a mobile phone service, an energy service, a cable service, or other service. The members may also participate in both offline and e-commerce activities that involve buying and selling of goods, buying electronic media, and so forth. The members have the opportunity to recruit additional members into the community. The recruited members become part of the member's network, and the member may be compensated based on the number of members (service subscribers) within his or her network, and may be compensated for other activities of the members in their networks, such as purchases made by the members within their network. The service prequalification services are available via the web and/or to mobile devices in order to allow social commerce community members to determine, on behalf of prospective members, whether the prospective members qualify for the offered services. The prequalification services may thus assist members of the social commerce community distribute one or more of these services to prospective members.

The service prequalification services are performed on a proactive basis, such as in order to offer a service to new potential social commerce community members, or to existing social commerce community members that are not currently subscribed to a particular service. Known information about the prospective subscriber is run through a prequalification engine to determine whether the prospective subscriber qualifies for the service. The known information may include the potential subscriber's location and equipment. A decision to offer a service, or to prequalify an existing member for the service, may be based on the potential subscriber's known interests, such as explicitly defined interests of the potential subscriber, or interests inferred from the potential subscriber's purchases, interactions, social network interactions, or other activity data.

Mobile service prequalification services according to various embodiments may include a geographical coverage checker to determine whether the mobile service is available in the geographic area(s) where the prospective subscriber lives, works, travels to, and so forth. The mobile service prequalification services may include a device checker to determine whether the prospective subscriber's pre-existing mobile device is compatible with the mobile service. This enables the prospective member to determine whether or not to subscribe to the service and whether to purchase a new phone, or to use their pre-existing mobile phone. Other mobile service prequalification services may be used without departing from the scope of embodiments. The mobile service prequalification services include an intelligence engine that determines whether the potential subscriber has an inferred or explicit interest in one or more services.

Once the service prequalification engine determines that a potential subscriber qualifies for a service, the service prequalification engine causes to be transmitted, or causes to be displayed, information that the potential subscriber qualifies for the service. The service prequalification engine may also transmit or cause to be displayed an offer to subscribe to the service.

### Example Environment

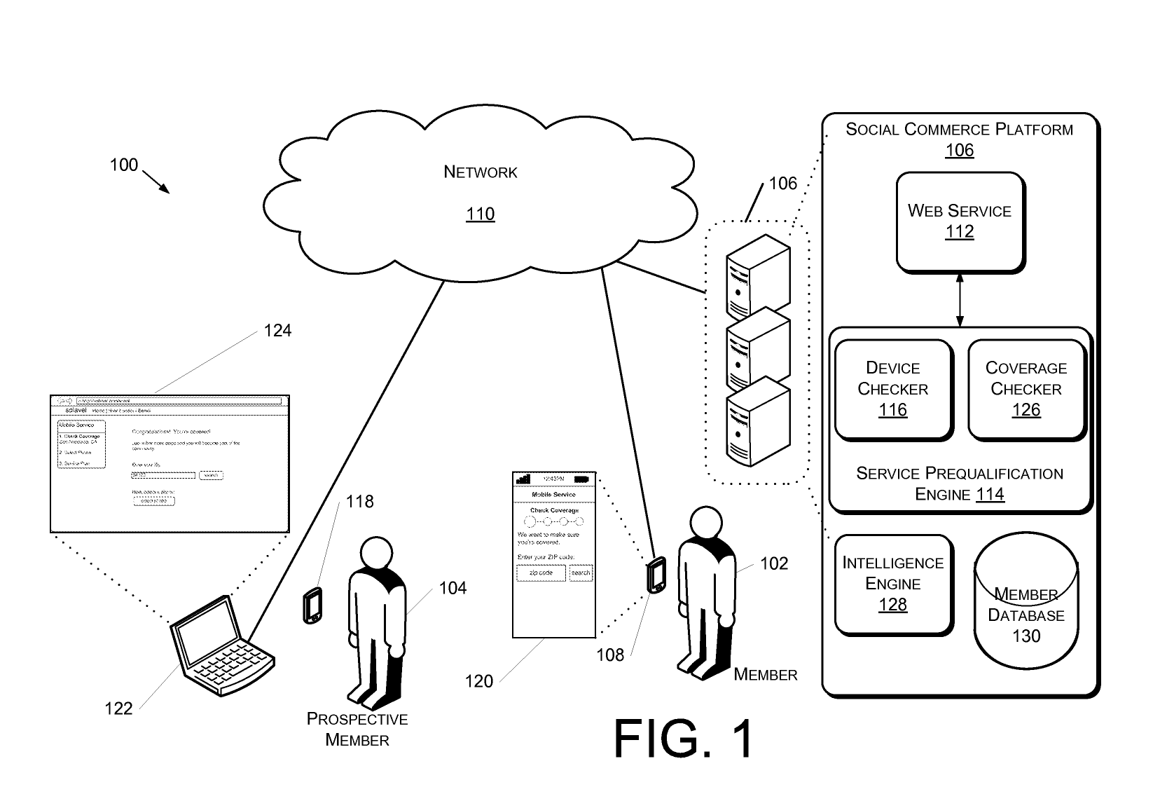

FIG. 1 illustrates an example environment 100 suitable for providing a mobile service prequalification service. Aspects of the environment 100 may be implemented on various suitable computing device types. Suitable computing device or devices may include, or be part of, one or more personal computers, servers, server farms, datacenters, special purpose computers, tablet computers, game consoles, smartphones, media players, combinations of these, or any other computing device(s).

Member 102 is a social commerce participant, and he or she may interact with a prospective member of the social commerce community, such as prospective member 104 or other prospective member. The member 102 may interact with a prospective member 104 in order to sign him or her up for mobile service and in order to get him or her to join the social commerce community. The member 102 may access a social commerce platform 106 using a mobile device 108 via a network 110. The mobile device 108 may have a web browser or other application(s) that accesses the social commerce platform 106, such as via the web service 112, in order to access service prequalification engine 114.

The service prequalification engine 114 is configured to receive prequalification information, such as location information, existing device information, to determine whether the prospective member qualifies for service. In embodiments, the service prequalification engine 114 includes a device checker 116. The device checker 116 determines whether the prospective member's 104 equipment is compatible with a service, such as a mobile phone service, a cable service, an energy service, an internet service, a satellite television service, and so forth. The prospective member 104 may have existing equipment compatible with the service, and may wish to re-use the existing equipment with the new service.

In one example where the service is a mobile service, the prospective member 104 may want to know whether his or her pre-existing mobile device 118 will function with the mobile service (such as a mobile telephone and/or data service) being offered by the member 102 and/or the social commerce platform 106. The mobile device 108 may access, either directly or via the web service 112, the device checker 116. The prospective member 104 may provide information regarding the pre-existing mobile device 118, such as a serial number, a brand, a model number, model name, or a device code. One example of a device code is an International Mobile Equipment Identity (IMEI) number. The device code uniquely identifies the pre-existing mobile device. To access the device code, the prospective member 104 or the member 102 may enter a command into the pre-existing mobile device 118. In the case of an IMEI number, the command may be “*#06#”, which is entered into the phone such as through a dialer interface of the pre-existing mobile device 118. The device code may also be accessed via a settings menu function. The device code may also be physically printed somewhere on the pre-existing mobile device 118, such as in the battery compartment or in another location.

The member 102 or the prospective member 104 may enter the device code of the pre-existing mobile device into the interface 120, and the mobile device 108 may transmit the device code, which is received by the device checker 116. The device checker 116 determines from the device code whether the pre-existing mobile device 118 is supported by the mobile service.

The device checker 116 may determine a level of service that the prospective member 104 is able to receive using his or her pre-existing equipment, based for example on the capabilities of the device. Where the service is a mobile service, for example, the device checker 116 determines a level of service that the pre-existing mobile device 118 can receive with the mobile service. Examples of mobile service levels includes availability of 2G, 3G, or 4G service, text, voice, data, ability to download an application for accessing various features of the social commerce platform 106, and so forth. The device checker 116 may transmit such information to the mobile device 108, and the information may be displayed on interface 120.

Similarly, the prospective member 104 or the member 102 may access the device checker 116 on the social commerce platform 106, such as via the web service 112, using a personal computer 122. The prospective member 104 (or the member 102) may enter the device code from the pre-existing mobile device 118 into the interface 124 provided by the web service 112. The device code is transmitted to the device checker 116, which determines the availability and/or level of service for the pre-existing mobile device 118, and causes information related to the availability and/or level of service to be displayed on the interface 124. Although not shown in FIG. 1, a browser or application on pre-existing mobile device 118 may also be used to access the device checker 116.

Although this description includes a description of the device checker 116 determining whether the pre-existing mobile device 118 is compatible with a mobile service, one or more embodiments of the device checker 116 may alternatively or additional be configured to check equipment service prequalification for other types of devices, such as personal computers, tablet computers, media players, and the like. The device checker may also be configured to check equipment service prequalification for other types of services, such as cable television services, wired or wireless internet services, energy services, satellite television services, and so forth.

The mobile device 108 and the personal computer 122 may also access a coverage checker 126 of the service prequalification engine 114, such as using a browser or other application via the web service 112. The member 102 or the prospective member 104 may enter information about the prospective member's geographic location, such as home or work address, ZIP or other postal code, or other information (such as GPS coordinates) into one of the interfaces 120 or 124. The geographic information is transmitted to the coverage checker 126, which determines whether the service, such as a mobile service, cable service, energy service, satellite television service, etc., is available in the geographic area.

The coverage checker 126 may cause information regarding coverage to be provided to the mobile device 108 and/or the personal computer 122 for display on interfaces 120 and 124.

The device checker 116 and/or the coverage checker 126 may also determine a level of service available to the prospective member 104 based on the received information regarding the geographic area/location or equipment of the prospective member 104. For example, where the service is a mobile service, the device checker 116 and/or the coverage checker 126 may determine the availability of 2G, 3G, or 4G services, text services, voice services, data services, the ability to download and run an application for accessing various features of the social commerce platform 106, and so forth. In another example, such as where the service includes a cable television service, the device checker coverage checker may determine the availability of certain television channels, pay-per-view options, and the like, at the prospective member's 104 location or using the prospective member's equipment. In another example, such as where the service includes wireless or wired internet service, the coverage checker 126 may determine the availability of certain bandwidth speeds available at the prospective member's 104 location or on the prospective member's 104 equipment. Other examples are possible without departing from the scope of embodiments.

The coverage checker 126 may cause information regarding availability of the service, and/or a level of service, at the prospective member's location to be provided to the mobile device 108 and/or the personal computer 122 for display on interfaces 120 and 124.

The social commerce platform 106 also includes an intelligence engine 128. The intelligence engine 128 may access a member database 130 to determine explicit or inferred interests of a member or prospective member, such as member 102. The intelligence engine 128 may determine from information stored in the member database 130 that the member 102 or the prospective member 104 has an interest in subscribing to a particular service, such as a mobile service, a cable television service, an energy service, and so forth. Based on this determination, the intelligence engine 128 may retrieve from the member database 130 other prequalification information, such as device and location information, and cause the device checker 116 and/or the coverage checker 126 to determine whether the member 102 or the prospective member 104 qualifies for the service. Based at least on this information, the intelligence engine may then cause transmission of a message, such as via the web service 112, or via another communication service such as text message, email, social commerce message, and the like, to the member 102 or the prospective member 104, such as via the mobile device 108. The message includes an offer to subscribe to the prequalified service, including an indication that the member 102 or the prospective member 104 qualifies for the service.

In situations where the member database 130 lacks information regarding the member 102 or prospective member's 104 equipment or location, the intelligence engine 128 may transmit, or cause to be transmitted, a message to the member 102 or the prospective member 104 informing them of the possibility of subscribing to the service, and providing a link or other communication mechanism to access the service prequalification engine 114, such as via the web service 112.

In a situation where the device checker 116 indicates that the prospective member 104 or the member 102 does not have pre-existing equipment that is compatible with the offered service, the service prequalification engine 114 provides a user interface screen or other communication that provides the member 102 or the prospective member 104 with an option to purchase equipment that is compatible with the service.

### Example Mobile User Interface Screens

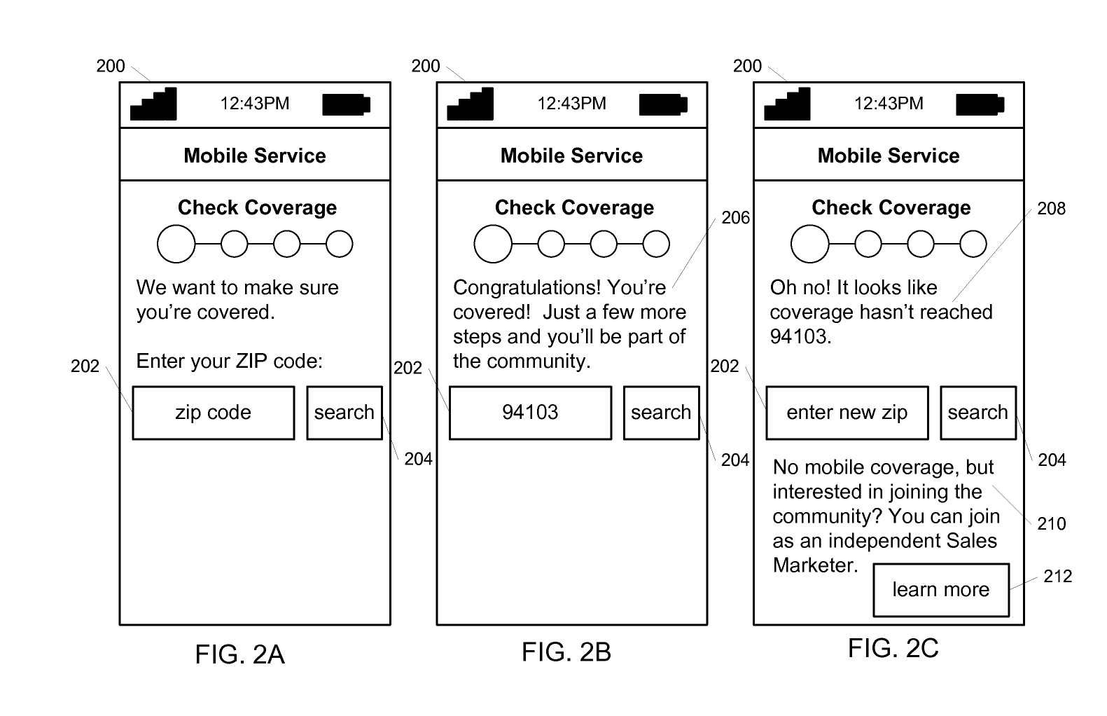

FIGS. 2A-C illustrate an interface 200 for a mobile-based coverage checker application, or mobile-web based mobile coverage checker, such as may be provided by web service 112. Interface 200 includes a field for entering a prospective member's location information, such as ZIP code field 202 for entering a prospective member's ZIP code. In the example shown in FIGS. 2A-C, selecting search button 204 results in transmitting the ZIP code to a coverage checker, such as the coverage checker 126. In other examples, other types of geographical information such as address, GPS information, mobile device location services, IP address, and so on may be entered into interface 200. The coverage checker returns information regarding the availability of a service at that location. As shown in FIG. 2B, the interface 200 returns an indication 206 that coverage is available at the entered ZIP code. Alternatively as shown in FIG. 2C, the interface 200 returns an indication 208 that coverage is not available at the entered ZIP code. In this case, the prospective member may be presented with information 210 regarding an option to join the social commerce community as a non-subscriber. Selection of option 212 enables the prospective member to learn more about options to become a non-subscriber member. ZIP code field 202 and search button 204 enable the prospective member to search for availability on a different ZIP code.

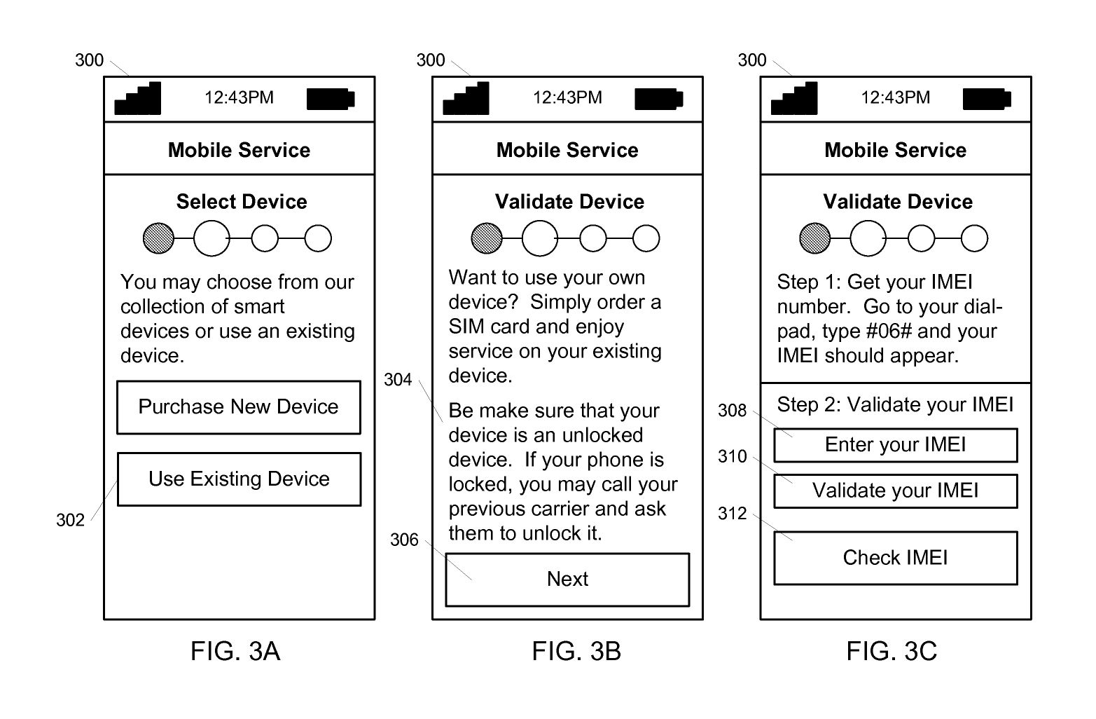

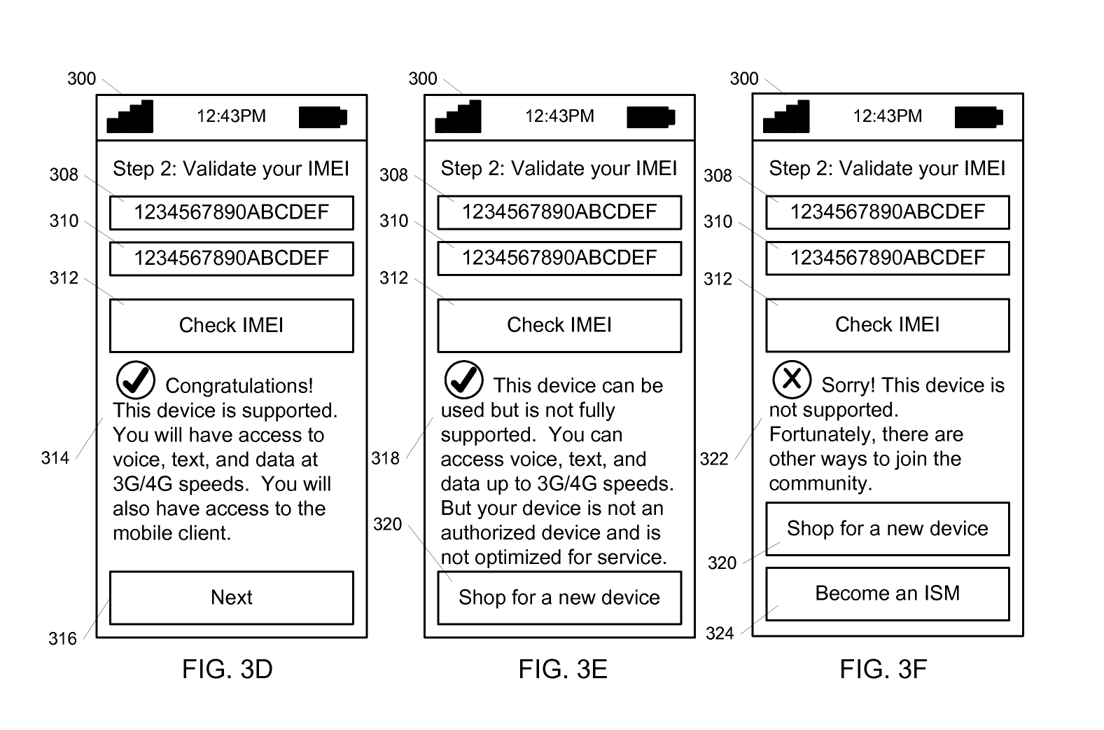

FIGS. 3A-F illustrate an interface 300 for a mobile-based device checker application, or mobile-web based mobile device checker, such as may be provided by web service 112. As shown in FIG. 3A, the interface 300 includes an option 302 to “Use Existing Device”. User selection of option 302 causes interface 300 to display instructions 304 requesting that the user make sure that the device is unlocked, as is shown in FIG. 3B. The “Next” button 306 is selective to proceed on to the user interface screen shown in FIG. 3C.

FIG. 3C illustrates fields 308 and 310 for entering a pre-existing mobile device's IMEI number into the interface 300, although other fields enabling entry of other identifying information of the existing device (such as make/model, serial number, and so forth) may be presented in interface 300. Selectable option 312 is provided to “Check IMEI”. Selecting of selectable option 312 causes the entered IMEI to be transmitted to a device checker, such as the device checker 116.

FIG. 3D illustrates interface 300 upon entry of an IMEI number into fields 308 and 310 and selection of selectable option 312 to check the compatibility of the device associated with the IMEI number. Information 314 indicates that the pre-existing mobile device associated with the entered IMEI number is supported by the mobile service. Selectable option 316 enables the user of the user interface 300 to proceed to a service subscription process.

FIG. 3E illustrates interface 300 upon entry of an IMEI number into fields 308 and 310 and selection of selectable option 312 to check the compatibility of the device associated with the IMEI number. Information 318 indicates that the pre-existing mobile device associated with the entered IMEI number is not fully supported on the mobile service. Selectable option 320 is selectable to proceed to a different interface screen that enables the user to shop for a new, fully supported device.

FIG. 3F illustrates interface 300 upon entry of an IMEI number into fields 308 and 310 and selection of selectable option 312 to check the compatibility of the device associated with the IMEI number. Information 322 indicates that the pre-existing mobile device associated with the entered IMEI number is not supported at all. The selectable option 320 is presented in this display to enable the user to purchase a compatible device. Selectable option 324 enables a member to become a non-subscriber member, or an “Independent Sales Marketer” or ISM.

### Example Web Interfaces

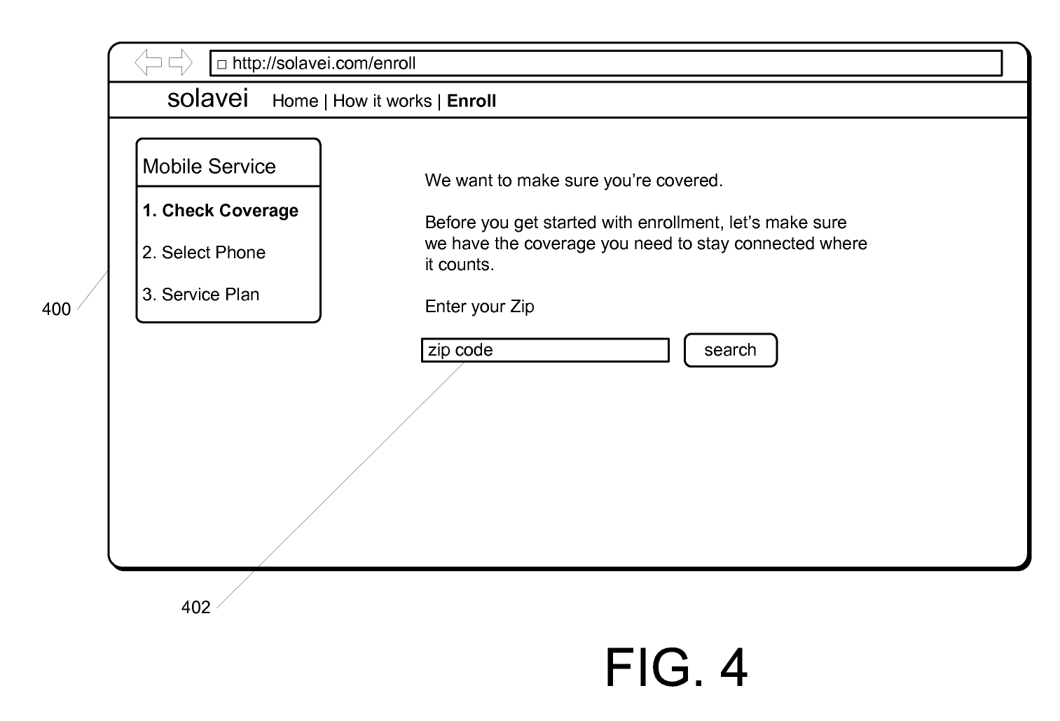

FIGS. 4-6 illustrate an example interface 400 for providing a web-based mobile service coverage check. As shown in FIG. 4, interface 400 includes field 402 for entering a ZIP code. In other examples, other types of geographical information such as address, GPS information, mobile device location services, IP address, and so on may be entered into interface 400.

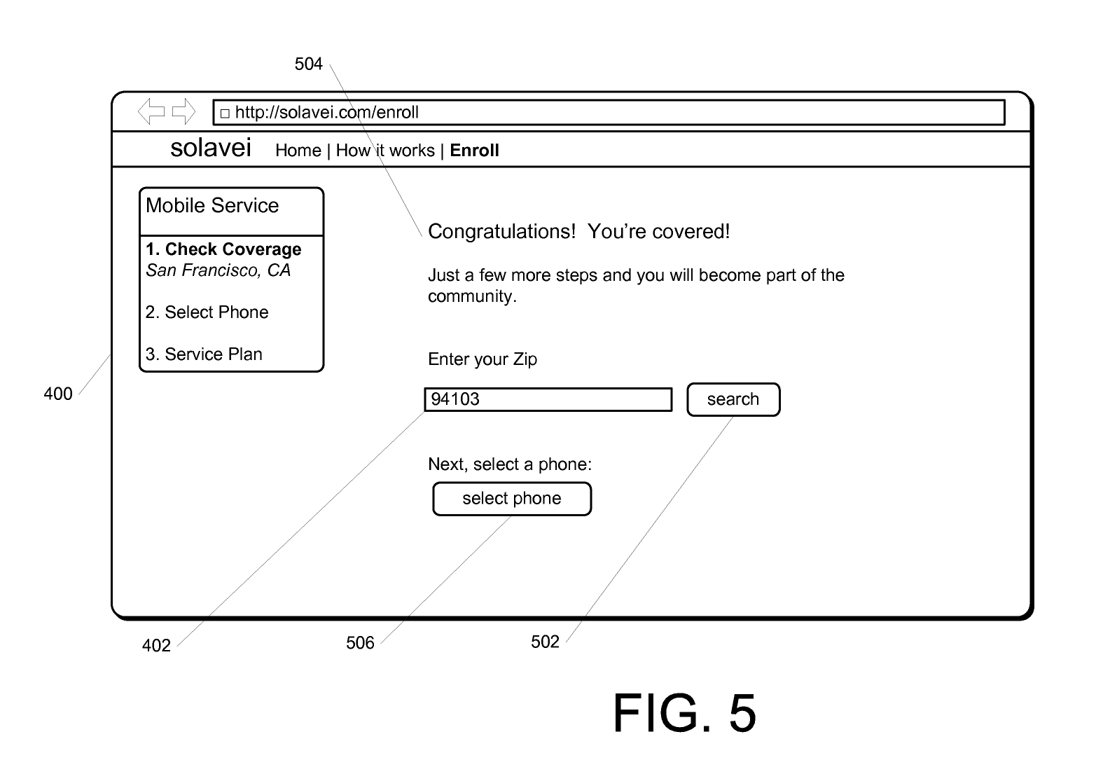

FIG. 5 illustrates interface 400 upon entry of a ZIP code into field 402 and selection of selectable search option 502 to check the service coverage at the prospective subscriber's location. Information 504 indicates that there is mobile service coverage in the geographic area associated with the entered ZIP code. Once the user is satisfied with the coverage, he or she may select selectable option 506 to proceed to check the compatibility of an existing mobile device.

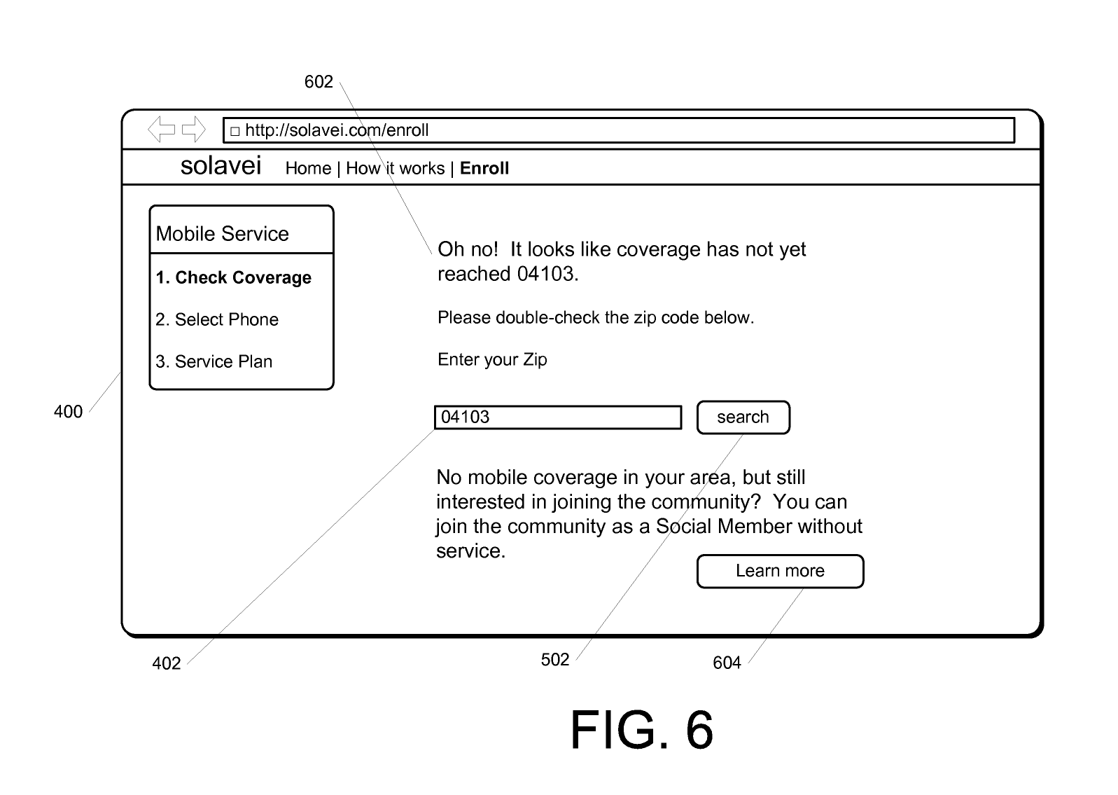

FIG. 6 illustrates interface 400 upon entry of a ZIP code into field 402 and selection of selectable search option 502 to check the service coverage at the prospective subscriber's location. Information 602 indicates that there is no mobile service coverage in the geographic area associated with the entered ZIP code. Selectable option 604 causes a new interface display that shows options for learning more about becoming a member of the community without subscribing to mobile service.

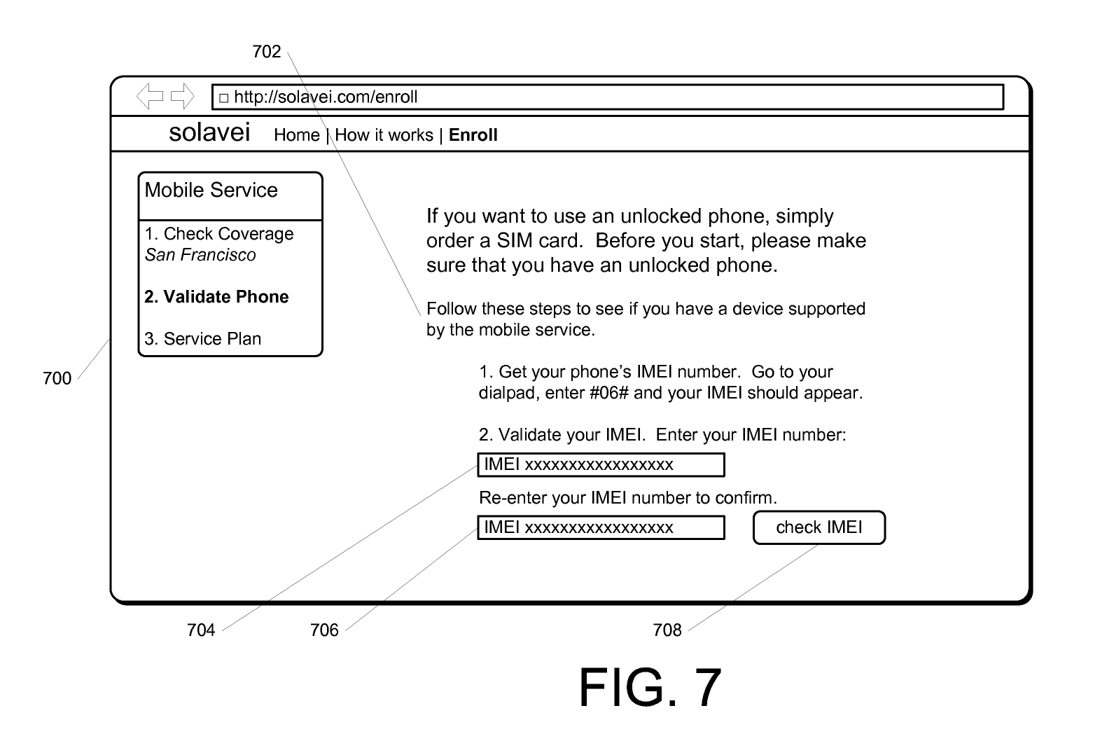

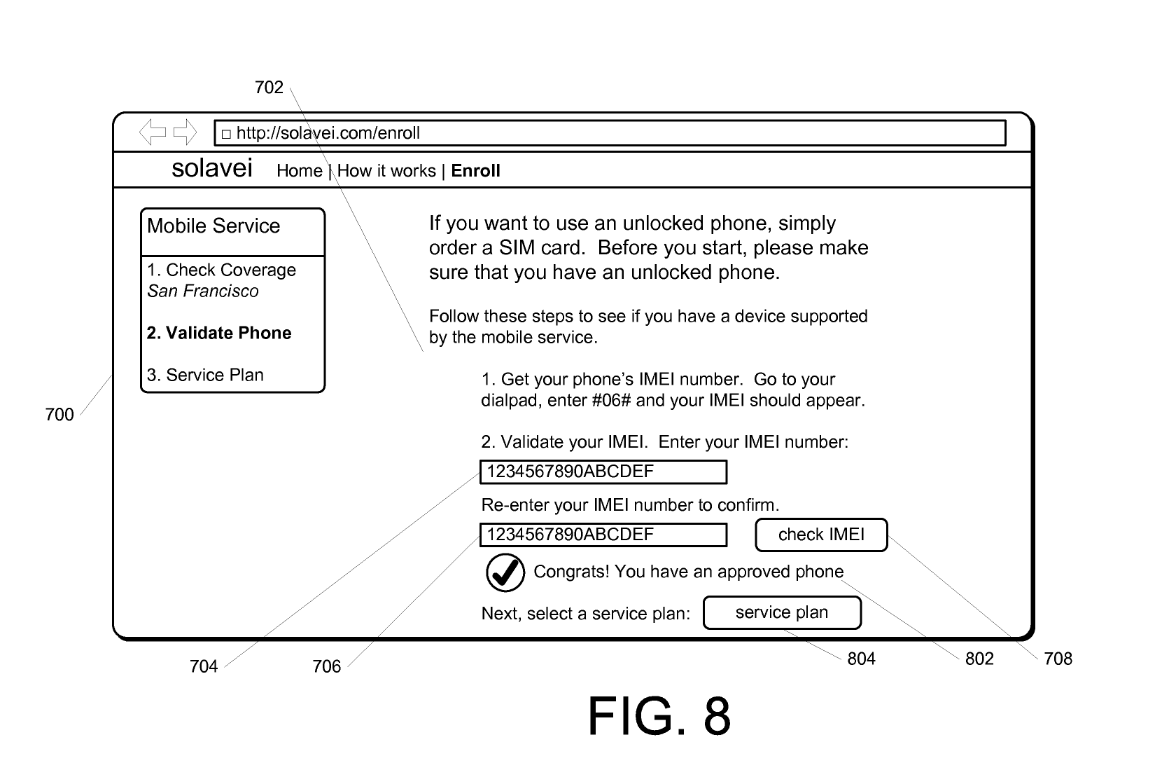

FIGS. 7 and 8 illustrate web interface 700 for performing a device check. As shown in FIG. 7, interface 700 includes information 702 explaining how to obtain the IMEI number of a pre-existing device. The interface 700 also includes fields 704 and 706 for entering the IMEI number, as well as a selectable option 708 for submitting the IMEI to a device checker, such as the device checker 118. In alternative embodiments, other fields enabling entry of other identifying information of the existing device (such as make/model, serial number, and so forth) may be displayed on interface 700.

FIG. 8 illustrates interface 700 upon entry of an IMEI number into fields 704 and 706 and selection of selectable option 708 to check the compatibility of the device associated with the IMEI number. Information 802 indicates that the pre-existing mobile device associated with the entered IMEI number is fully supported. Upon learning that their pre-existing mobile device is an approved phone, the user may select selectable option 804 to proceed to a service plan selection and become a subscriber. If the pre-existing mobile device is only partially covered or not covered at all, then the interface 700 may display information indicating such information. If the device is only partially supported, then the interface 700 may also display information describing the limited functionality in terms of features and services available, and/or features and services that are not available, with the pre-existing mobile device.

Although the user interface screens shown in FIGS. 2-8 illustrate user interfaces for interacting with a social commerce system to perform prequalification for a mobile service and devices, the same or similar user interface screens may be used according to embodiments to interact with a social commerce system for prequalifying other types of services, such as energy service, cable television service, internet access service, and so forth. Various embodiments may also cause display of the same or similar interfaces for prequalifying other types of devices, such as wireless modems, cable television modems, energy service smart meters, cable set-top boxes, satellite receiving equipment, and so forth.

### Example Computing System

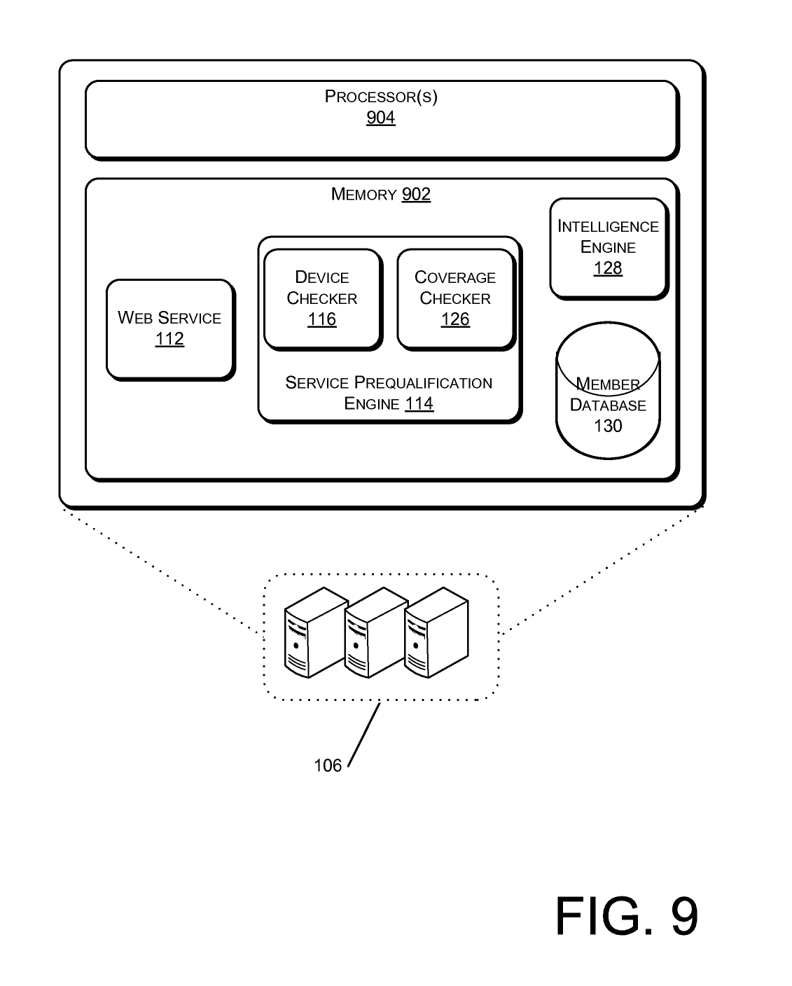

FIG. 9 is a block diagram of an example computing system usable to provide the social commerce platform 106. The social commerce platform 106 may be configured as any suitable computing device or computing devices capable of implementing service prequalification services. According to various non-limiting examples, suitable computing devices may include or be part of personal computers (PCs), servers, server farms, datacenters, special purpose computers, tablet computers, game consoles, smartphones, media players, combinations of these, or any other computing device(s).

Memory 902 may store computer-readable or computer-executable instructions that are loadable and executable on the processor(s) 904, as well as data generated during execution of, and/or usable in conjunction with, these programs. For example, the memory 902 includes the web service 112, the service prequalification engine 114, which includes the device checker 118 and the coverage checker 126. The memory 902 also includes the intelligence engine 128 and the member database 130

### Example Process

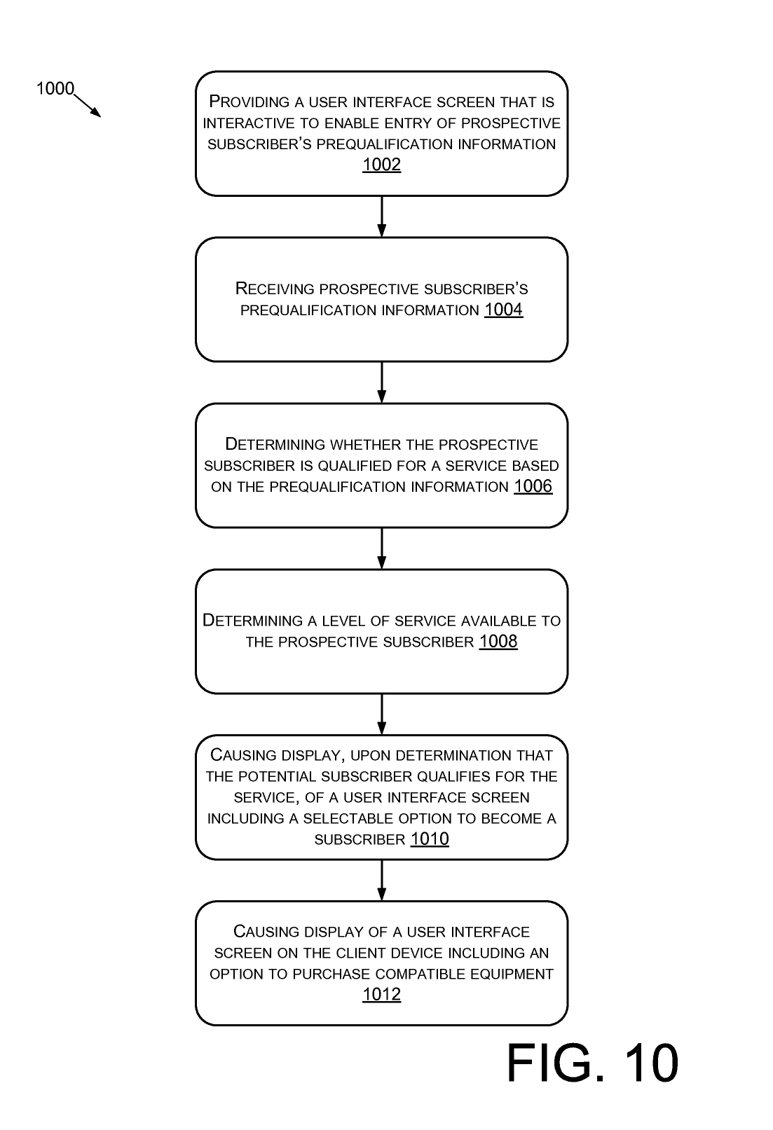

FIG. 10 illustrates a flow chart depicting a process 1000 of service prequalification. At 1002, a social commerce platform, such as the social commerce platform 106, provides to a client computing device a user interface screen that is interactive to enable entry of prequalification information, such as one or more of information including one or more of a potential service subscriber's location and a potential service subscriber's equipment, and so forth. The user interface screen may be a user interface screen on a mobile device, such as the mobile device 108 or the mobile device 118, or on a personal computing device, such as the personal computer 122.

At 1004, the social commerce platform receives, from the client computing device, the prospective member's prequalification information, such as one or more of a potential service subscriber's location and a potential service subscriber's equipment. The prequalification information may include one or more of a postal code, a street address, a city, a state, a country, a province, and a location coordinate. The prequalification information may include one or more of a serial number of the potential service subscriber's equipment, a brand of the potential subscriber's equipment, or a model number of the potential service subscriber's equipment. In a particular embodiment, the prequalification information includes an International Mobile Equipment Identity (IMEI) number for the potential subscriber's equipment.

At 1006, the social commerce platform determines, based at least on the received prequalification information (i.e., location and/or equipment information), whether the potential service subscriber qualifies for a service. The service may include one or more of a mobile telephone or data service (also referred to herein as a “mobile service), an energy service, a cleaning service, a lawn care service, a cable service, an internet access service, and so forth. In embodiments, the determination whether the potential service subscriber qualifies for service includes a determination that there is geographical overlap, or other geographical correlation, between the potential service subscriber's location and a service area of the service. In the same or other embodiments, the determination whether the potential service subscriber qualifies for service includes a determination that the potential service subscriber's equipment matches a predetermined list of equipment that is compatible with the service. For example, where the service is a mobile service, the determination may include a determination whether an IMEI number for a mobile device matches a list of IMEI numbers of mobile devices that are compatible, or at least partly compatible, with the mobile device.

At 1008, the social commerce platform determines, based at least on the prequalification information (i.e., the prospective member's location and/or equipment), a level of service available to potential service subscriber. In embodiments where the service is a mobile service, the level of service may include 2G, 3G, 4G service, voice service, data service, ability to use mobile-optimized applications used for interacting with the social commerce community, and so forth. In embodiments, where the service is a cable television service, the level of service may include available television channels, availability of digital cable, availability of pay-per-view options, etc. In embodiments where the service is an energy service, the level of service may include availability of smart meter capabilities, alternative energy sources (such as wind, solar, etc.), and so on. Other service levels may be used in various embodiments without departing from the scope of the present disclosure

At 1010, the social commerce system causes display, on the client computing device upon a determination that the prospective service subscriber qualifies for the service, of a user interface screen that indicates that the prospective service subscriber qualifies for service. The user interface screen may include a selectable option to proceed to a service subscription process. In embodiments, causing display includes transmitting an indication to the client computing device that the potential service subscriber does or does not qualify for the service.

At 1012, the social commerce system causes, upon a determination that the potential service subscriber's equipment does not match the predetermined list of compatible equipment, display of a user interface screen on the client computing device that includes an option, such as the selectable option 318, to purchase new equipment that is compatible with the service.

### Computer-Readable Media

Depending on the configuration and type of computing device used, memory 902 may include volatile memory (such as random access memory (RAM)) and/or non-volatile memory (such as read-only memory (ROM), flash memory, etc.). Memory 902 may also include additional removable storage and/or non-removable storage including, but not limited to, flash memory, magnetic storage, optical storage, and/or tape storage that may provide non-volatile storage of computer-readable instructions, data structures, program modules, and other data.

Memory 902 is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions (also referred to as executable instructions), data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### CONCLUSION

Although the disclosure uses language that is specific to structural features and/or methodological acts, the invention is not limited to the specific features or acts described. Rather, the specific features and acts are disclosed as illustrative forms of implementing the invention.

We claim:

1. A system comprising:
one or more processors;
memory; and
a plurality of executable instructions stored on the memory and executable by the one or more processors to:
receive, from a client computing device, prequalification information of a potential service subscriber;
determine, based at least on the prequalification information, whether the potential service subscriber qualifies for a service; and
transmit, to the client computing device, an indication that the potential service subscriber does or does not qualify for the service.

2. The system of claim 1, wherein the prequalification information includes one or more of a potential service subscriber's location and a potential service subscriber's equipment

3. The system of claim 1, wherein the prequalification information includes one or more of a postal code, a street address, a city, a state, a country, a province, and a location coordinate.

4. The system of claim 1, wherein the prequalification information includes one or more of a serial number of the potential service subscriber's equipment, a brand of the potential subscribers equipment, and a model number of the potential service subscriber's equipment.

5. The system of claim 1, wherein the prequalification information includes an International Mobile Equipment Identity (IMEI) number.

6. The system of claim 1, wherein the service includes one or more an energy service, a cable service, and an internet access service.

7. The system of claim 1, wherein the determination whether the potential service subscriber qualifies for service includes a determination that there is geographical overlap between the potential service subscriber's location and a service area of the service.

8. The system of claim 1, wherein the determination whether the potential service subscriber qualifies for service includes a determination that the potential service subscriber's equipment matches a predetermined list of compatible equipment.

9. The system of claim 8, wherein the plurality of executable instructions are further executable by the one or more processors to cause, upon a determination that the potential service subscriber's equipment does not match the predetermined list of compatible equipment, display of a user interface screen on the client computing device, the user interface screen including an option to purchase new equipment that is compatible with the service.

10. The system of claim 1, wherein the plurality of executable instructions are further executable by the one or more processors to determine, based at least on the prequalification information, a level of service available to potential service subscriber and to transmit an indication of the level of service to the client computing device.

11. The system of claim 10, wherein the level of service is determined based on capabilities of the potential subscriber's equipment.

12. The system of claim 10, wherein the level of service is determined based on service offerings available in a service area corresponding to the potential subscriber's location.

13. One or more computer-readable media having stored thereon instructions that are executable by one or more processors of a computing device to:
provide a first user interface screen to a client computing device for display on a display of the client computing device, the first user interface screen interactive to enable user entry prequalification information;
receive the prequalification information from the client computing device;
determine, based at least on the prequalification information, whether the potential service subscriber qualifies for a service; and
transmit, to the client computing device, a second user interface screen for display on the client computing device, the second user interface screen including a definite indication that the potential service subscriber does or does not qualify for the service.

14. The one or more computer-readable media of claim 13, wherein the prequalification information includes one or more of a potential service subscriber's location and a potential service subscriber's equipment

15. The one or more computer-readable media of claim 13, wherein the prequalification information includes an International Mobile Equipment Identity (IMEI) number of the potential subscriber's equipment.

16. The one or more computer-readable media of claim 13, wherein the instructions are further executable by the one or more processors to determine, based at least on the prequalification information, a level of service available to the potential subscriber, and wherein the second user interface screen or a third interface screen includes an indication of the level of service.

17. The one or more computer-readable media of claim 16, wherein the level of service includes a level of mobile service available based on one or more of capabilities of the potential subscriber's equipment and service coverage available at the potential subscriber's location.

18. The one or more computer-readable media of claim 13, wherein the determination that the potential service subscriber qualifies for the service includes a determination that the potential service subscriber's equipment matches a predetermined list of compatible equipment.

19. The one or more computer-readable media of claim 13, wherein the determination whether the potential service subscriber qualifies for service includes a determination that there is geographical overlap between the potential service subscriber's location and a service area of the service.

20. A method, comprising:
receiving, by a social commerce system from a client computing device, information regarding one or more of a prospective subscriber's location or the prospective subscriber's equipment;
determining, based at least on the information, whether the prospective subscriber is qualified for a service; and
causing display, on the client computing device upon a determination that the prospective service subscriber qualifies for the service, of a user interface screen, the user interface screen including a selectable option to proceed to a service subscription process.

21. The method of claim 20, wherein the causing display includes transmitting an indication to the client computing device, the indication indicating that the potential service subscriber qualifies for the service.

22. The method of claim 20, further comprising determining, based at least on the information, a level of service available to potential service subscriber and to transmit an indication of the level of service to the client computing device.

23. The method of claim 22, wherein the level of service is determined based on capabilities of the potential subscriber's equipment.

24. The method of claim 22, wherein the level of service is determined based on service offerings available in a service area corresponding to the potential subscriber's location.
